(19) United States
(12) Patent Application Publication
(10) Pub. No.: US 2006/0145660 A1
(43) Pub. Date: Jul. 6, 2006

(54) Method and apparatus for near field communications

(76) Inventors: Greg R. Black, Vernon Hills, IL (US); Simone Koo, Palatine, IL (US); Deven M. Patel, Antioch, IL (US)

Correspondence Address: MOTOROLA INC, 600 NORTH US HIGHWAY 45, ROOM AS437, LIBERTYVILLE, IL, 60048-5343, US

(21) Appl. No.: 11/299,146

(22) Filed: Dec. 8, 2005

Related U.S. Application Data
(60) Provisional application No. 60/640,487, filed on Dec. 30, 2004.

(51) Int. Cl. H02J 7/00

(52) U.S. Cl. 320/108

(57) ABSTRACT

Disclosed herein is a method and apparatus for inductively charging a battery. The battery comprises a housing (102), at least one battery cell (104) carried in the housing and a multimode near field transceiver (106) carried also in the housing. The near field transceiver is operable in a passive mode to provide information and active mode to exchange information. The battery further comprises a charging coupler (108) coupled to the cell through a charging circuit (110) and a communication coupler (112) or antenna coupled to the transceiver.

### CROSS REFERENCE TO RELATED APPLICATIONS

This application claims the benefit of U.S. provisional application No. 60/640,487, filed on 30 Dec. 2004, and entitled Methods And Apparatus for Near Field Communication, the disclosure of which is incorporated herein by reference.

### FIELD OF THE INVENTION

The present invention relates generally to device identification through radio frequency communications and more particularly through the use of near field communications.

### BACKGROUND OF THE INVENTION

Passive radio frequency identification (RFID) tags are known. Near field communication devices may use RFID tags to exchange information and in particular in personal area networks (PANs) to identify one device to another. Inductive charging of rechargeable batteries is also known. However, when charging multiple devices inductively, such as a plurality of devices, each device may require different voltage and current levels to recharge the battery.

Some devices require high power in the charger, so for safety and efficiency it is necessary that the charging process begin with the detection and identification of the devices to be charged. This detection and identification requires wireless communication between the charger and the battery powered device or stand-alone battery. A fully depleted battery or battery that is removed from the device and placed on the inductive charger will not be able to communicate with the charger to provide the identification.

What is needed is a method and apparatus for device identification in inductive charging systems. The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

The various aspects, features and advantages of the present invention will become more fully apparent to those having ordinary skill in the art upon careful consideration of the following Detailed Description of the Drawings with the accompanying drawings described below.

FIG. 1 is an exemplary block diagram of a near field device and inductive charger.

FIG. 2 is an exemplary block diagram of a near field device and inductive charger.

FIG. 3 is an exemplary device identification and charging flow diagram.

FIG. 4 is an exemplary device identification and charging flow diagram.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular device identification method and apparatus in accordance with the present invention, it should be understood that the present invention resides primarily in combinations of method steps and apparatus components related thereto. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

Disclosed herein is a method and apparatus for inductively charging a battery. The battery comprises a housing, at least one cell carried in the housing and a multimode near field transceiver carried also in the housing. In one exemplary embodiment, the transceiver is operable in a passive mode to provide information. The battery further comprises a charging coupler coupled to the battery through a charging circuit and a communication coupler or antenna coupled to the transceiver.

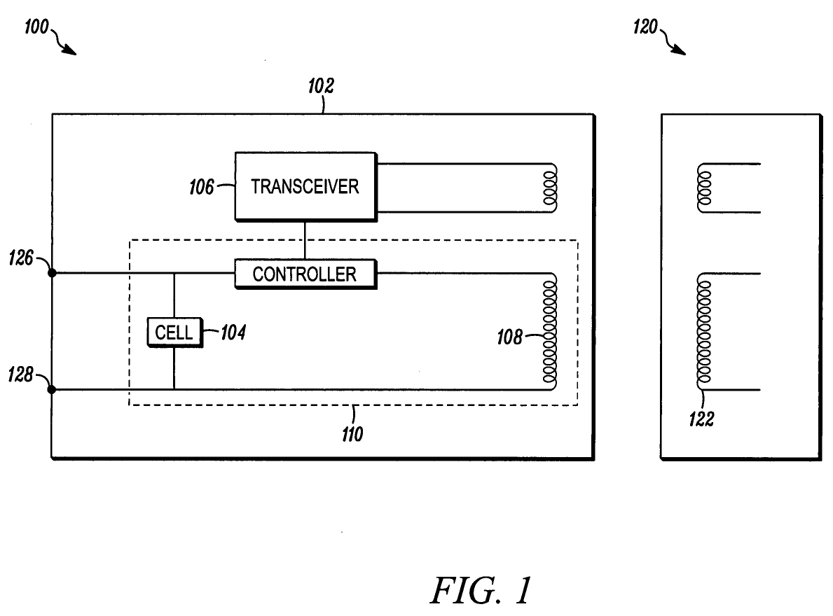

Illustrated in FIG. 1, exemplary battery 100 is shown comprising a housing 102, at least one battery cell 104 carried in the housing and a multi mode near field (NFC) transceiver 106 also carried in the housing 102. The multimode NFC transceiver 106 is operable in a passive mode to provide information and an active mode for transmitting and receiving information such as from other NFC devices. When power is available, either from the battery itself or an alternative source, the transceiver in this embodiment may operate as an active transceiver. When power is not available, the passive transceiver may only provide information that is stored in a memory. For example, when power is not available the transceiver is operable in a passive mode to provide a device ID. The device ID in this embodiment would be transmitted to the charger to indicate the battery type thereto.

Further in this exemplary embodiment, the battery 100 comprises a charging coupler 108 coupled to the cell 104 through a charging circuit 110. A communications coupler 112 is coupled to the transceiver 106. The charging coupler 108 in this embodiment inductively couples the charging circuit 110 of the battery 100 to an inductive charger 120 via a charger charging coupler 122. It is understood that other charging circuits known to those skilled in the art may also be used. For example, in one embodiment, the charging circuit 110 is a schottky diode. When the battery 100 is coupled to a device such as a radiotelephone or the like, data from the device may be sent to the transceiver 106 for transmission or received and passed to the device. The battery cell 104 of the battery 100 may be coupled to the transceiver such that the near field transceiver 106 and the electronic device are powered by the at least one battery cell.

An electronic device coupled to the battery is used for exemplary purposes only and it is to be understood that numerous electronic devices may apply. The radiotelephone described herein is a representation of the type of a wireless communication device that may benefit from the present invention. However, it is to be understood that the present invention may be applied to any type of hand-held or portable electronic device including, but not limited to, the following devices: radiotelephones, cordless phones, paging devices, personal digital assistants, portable computers, pen-based or keyboard-based handheld devices, remote control units, portable media players such as an audio player (such as an MP3 player) and the like. Accordingly, any reference herein to the electronic device should also be considered to apply equally to other hand-held or portable electronic devices.

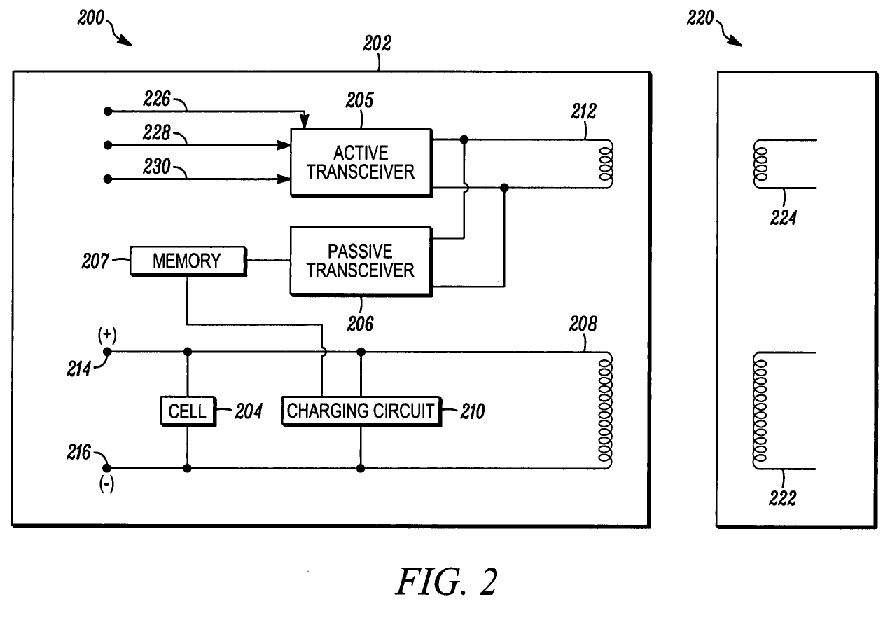

In another embodiment illustrated in FIG. 2, a battery 200 and charger 220 are shown. The battery comprises a housing 202, a cell 204, an active transceiver 205 and a passive transceiver 206. The battery 200 also comprises a memory 207 a charging coupler 208, and a charging circuit 210 which is coupled to the cell 204. A communication coupler 212 is coupled to the active transceiver 205 and the passive transceiver 206. The memory 207 may be carried in the housing 202 or may be a component of the electronic device when the battery 200 is coupled thereto. The battery 200 also comprises a first terminal 214 and a second terminal 216 to electrically couple the device to the cell 204 in the battery 200 to thereby provide power.

In the exemplary embodiment shown in FIG. 2, the communication coupler 212 is shown as a first coil 212 and the charging coupler 208 is shown as a second coil 208. The communication coupler 212 may be an inductor or an antenna. The first coil 212 may be a portion of the second coil 208. The length and number of coils will determine the operational frequency of the coil. The first coil 212 may therefore be formed by tapping into a portion of the second coil at a predetermined number of coils to operate at the desired frequency range. In this embodiment, the battery further comprises an element, the second coil, coupled to the at least one cell and to the transceiver, the element providing an antenna for the transceiver and a charging coupler for the at least one cell.

The inductive charger 220 comprises a charger charging coupler 222 and a charger communication coupler 224. The charger charging coupler 222 inductively couples with the charging coupler 208 of the battery 200. The charger communication coupler 224 couples, or is used to form a wireless link with the communication coupler 212 of the battery 200. When a battery 200 is placed in range of the inductive charger, communications between the battery and the charger may take place and inductive charging can occur. In one exemplary embodiment, the inductive charger 220 has a flat surface upon which the battery may be placed and rest in near field range and remain while charging operations occur.

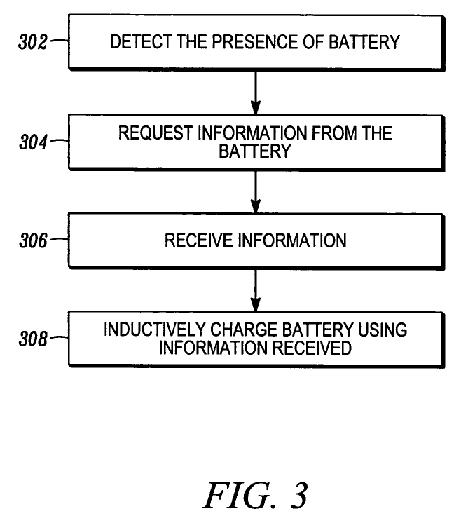

An exemplary method of controlling a battery includes receiving charging power from a near field source by the battery 100 and transmitting from a near field transceiver 106, operating in a passive mode, information indicating cell charging information such as a profile or the like. An exemplary flow diagram, shown in FIG. 3, illustrates a device identification and charging procedure. In step 302 the charger 120 detects the presence of a near field communication (NFC) device. In this exemplary embodiment the NFC device is the battery 100, 200. The charger 120 requests, in step 304, information from the device 100. The battery may respond with information, the device ID for example.

If the battery has the capacity to provide power, more information may be transmitted to the charger 120, such as the type of device the battery 100 is coupled to, encryption information, battery characteristics or charging profile or the like. The information may come from the battery memory 207 or memory in the device. The battery may also only send a Device ID, charging profile or the like, particularly when only the passive transceiver can operate because, for example the battery has been depleted and no other power source is available.

The charger receives, in step 306 the information and based thereon, inductively charges, in step 308, the battery 100. To determine how to inductively charge the battery 100, the charger 120, in one exemplary embodiment, may use a lookup table or database to compare the information sent by the battery to that in the charger 120, such as device ID to indicate a valid battery, to determine the charger profile or settings for that particular battery 100. If more information is sent by the battery 100, the charger 120 may use that information to set the charging parameters.

The method further includes permitting the operation of the near field transceiver in a non-passive mode when the at least one cell 104 is at least partially charged or the device has power available from an alterative source. In this exemplary embodiment, the method may further include the step of transmitting data received from a master device in the active mode, data from the master device. The non-passive transceiver reads information from other passive or non-passive receivers within range. The data received may be stored in the memory 207 of the battery or in the device coupled thereto. The battery 100 may also transmit information such as a battery cell charging state. This for example may include, charging, charged, percent charge or charge level or the like. The transceiver may communicate the charging status while the at least one cell is charging.

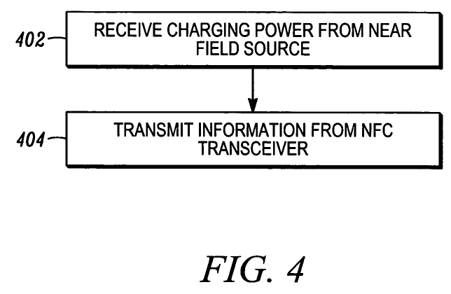

An exemplary illustrated in FIG. 4 shows a flow diagram of the method of controlling a battery which includes receiving 402 charging power from a near field source by the battery 100 and transmitting 404 from a NFC transceiver 106. The battery may transmit the information from the near field transceiver 106 prior to receiving charging power form the near field source. The batter may also transmit information be the NFC transceiver during the receiving of charging power such as charge level and battery characteristics.

The information transmitted may also include information related to the near field signals such as signal strength. The method would comprise the step of monitoring the near field and then enabling the charging of the battery cell when the near field present is suitable for charging the cell.

The multimode transceiver, operational as both a passive transceiver and an active transceiver may operate in a passive or tag mode without power, powered passive or tag mode, powered reader mode, powered peer to peer mode.

When the battery has a sufficient charge, the active transceiver 205 may operate in powered reader mode. This allows the battery to send and receive communications, near filed communications, whether or not the battery is coupled to a device. In this exemplary embodiment, the battery may be removed from the device and placed on the inductive charger and charged without being coupled to the device and the charger can still acquire information pertaining to the battery and how it is to be charger.

When the battery is coupled to a device, information can be sent to and retrieved from the device. When the battery is not coupled to the device, information may be sent to and from the memory carried in the battery 100. The battery includes a first port 226 connected to the transceiver 106 for coupling to the electronic device, the first port 228 is for passing signals to control the transceiver operation in at least a reader mode or a peer-to-peer mode. The battery may also include a second port 228 coupled to the transceiver, the second port 228 for inputting data from an external device. A third port 230 may supply power from the external device.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A battery comprising:
a housing;
at least one battery cell carried in said housing; and
a multi-mode near field transceiver carried in said housing.

2. The battery as defined in claim 1, wherein the transceiver is operable in a passive mode to provide a device ID.

3. The battery as defined in claim 2, further comprising an antenna coupled to the transceiver.

4. The battery as defined in claim 1, further comprising a charging circuit coupled to said at least one cell through a battery charging circuit.

5. The battery as defined in claim 4, wherein the charging circuit includes a schottky diode.

6. The battery as defined in claim 4, further comprising an element coupled to said at least one cell and to said transceiver, the element providing an antenna for said transceiver and a charging coupler for said at least one cell.

7. The battery as defined in claim 2, wherein the transceiver is further operable in a passive mode to provide a charging profile to a charging base.

8. The battery as defined in claim 7, wherein the transceiver communicates the charging status while said at least one cell is charging.

9. The battery as defined in claim 1, further including a port connected to the transceiver for coupling to an electronic device, the port for passing signals to control the transceiver operation in at least a reader mode or a peer-to-peer mode.

10. The battery as defined in claim 9, wherein the transceiver and said electronic device are powered by said at least one cell.

11. The battery as defined in claim 1, further including a second port coupled to the transceiver, said second port for inputting power from an external device.

12. A method of controlling a battery, comprising:
receiving charging power from a near field source;
transmitting from a near field transceiver operating in a passive mode information indicating cell charging information.

13. The method as defined in claim 12, further including permitting the operation of the near field transceiver in a non-passive mode when the at least one cell is at least partially charged.

14. The method as defined in claim 13, further including the step of transmitting data received from a master device in the active mode, data from the master device.

15. The method as defined in claim 12, wherein the step of transmitting includes transmitting the cell charging state.

16. The method as defined in claim 12, further comprising the step of transmitting a battery identification indicating that it is a valid battery.

17. The method as defined in claim 12, further comprising the step of monitoring the near field.

18. The method as defined in claim 12, further comprising the step of enabling charging of the cell when the near field present is suitable for charging the cell.

19. A battery comprising:
a housing;
an active transceiver carried in the housing;
a passive transceiver carried in the housing;
a communication coupler coupled to the active transceiver and the passive transceiver;
a memory coupled to the passive transceiver;
at least one rechargeable battery cell
a charging circuit coupled to the at least one battery cell; and
a charging coupler coupled to the charging circuit, wherein the charging coupler is configured to couple to at least an inductive charger.

20. The battery as defined in claim 19, wherein a device ID is stored in the memory.
